(19) United States
(12) Patent Application Publication
(10) Pub. No.: US 2018/0340462 A1
(43) Pub. Date: Nov. 29, 2018

(54) FLANGE JOINING STRUCTURE

(71) Applicant: HONDA MOTOR CO., LTD, Tokyo (JP)

(72) Inventors: Minoru Hideshima, Wako-shi (JP); Noritaka Yamamoto, Wako-shi (JP)

(73) Assignee: HONDA MOTOR CO., LTD, Tokyo (JP)

(21) Appl. No.: 15/982,277

(22) Filed: May 17, 2018

(30) Foreign Application Priority Data
May 23, 2017 (JP) 2017-101466

(51) Int. Cl. F01N 13/18; F16L 23/16

(52) U.S. Cl. CPC F01N 13/1827; F01N 2450/24; F16L 23/16; F01N 13/1855

(57) ABSTRACT

A flange joining structure comprises flanges of a cylinder head of an internal combustion engine and a turbine housing joined through a gasket. The flange of cylinder head has, in an end face thereof, end parts of a first collecting exhaust pipe and a second collecting exhaust pipe; the flange of turbine housing has, in an end face thereof, end parts of a first pre-merge exhaust pipe and a second pre-merge exhaust pipe corresponding to the end parts of the first collecting exhaust pipe and the second collecting exhaust pipe; and the gasket has, on a face on the cylinder head side, a bead formed into an edge-rounded rectangle having a straight part shorter than the radius of curvature thereof, and surrounding the end parts of the first collecting exhaust pipe and the second collecting exhaust pipe.

### CROSS REFERENCES TO RELATED APPLICATIONS

The present application claims priority under 35 U.S.C. § 119 to Japanese Patent Application No. 2017-101466, filed May 23, 2017, entitled “ FLANGE JOINING STRUCTURE.” The contents of this application are incorporated herein by reference in their entirety.

### TECHNICAL FIELD

The present disclosure relates to a flange joining structure. More specifically, the disclosure relates to a flange joining structure in which a flange formed in a cylinder head of an internal combustion engine and a flange formed in an exhaust member are connected through a plate-like gasket.

### BACKGROUND

Heretofore, a gasket has been provided between a flange formed in a cylinder head of an internal combustion engine and a flange formed in an exhaust member of an exhaust pipe, a turbine housing, or the like, to prevent leakage of exhaust gas between the cylinder head and exhaust member. For example, Japanese Patent Application Publication No. Hei 10-169456 discloses a technique of joining a flange of a cylinder head and a flange of an exhaust gas turbine through a plate-like gasket. In the technique of Japanese Patent Application Publication No. Hei 10-169456, each of the flange of the cylinder head and the flange of the exhaust gas turbine has two substantially rectangular openings each connected to two exhaust passages. Additionally, in the technique of Japanese Patent Application Publication No. Hei 10-169456, the flanges are joined through a gasket that has a substantially rectangular through hole surrounding the two openings.

### SUMMARY

Incidentally, since high-temperature exhaust gas continuously flows through the inside of the flange of the cylinder head and the flange of the turbine housing, end faces of both flanges deform slightly by heat of exhaust gas. Hence, the flange joining structure using the plate-like gasket disclosed in Japanese Patent Application Publication No. Hei 10-169456 may be incapable of maintaining a sufficient sealing property because of the heat of exhaust gas.

Thus, it is preferable to provide a flange joining structure that can maintain a sealing property even when high-temperature exhaust gas continuously flows therethrough.

(1) A flange joining structure joins a flange (e.g., later-mentioned flange 21) formed in a cylinder head (e.g., later-mentioned cylinder head 2H) of an internal combustion engine (e.g., later-mentioned internal combustion engine 2) and a flange (e.g., later-mentioned flange 22) formed in an exhaust member (e.g., later-mentioned turbine housing 4) through a gasket (e.g., later-mentioned gasket 23). The flange joining structure is characterized in that: multiple openings (e.g., later-mentioned upstream openings 11a, 12a) of multiple exhaust passages (e.g., later-mentioned collecting exhaust pipelines 11, 12) connected to a combustion chamber of the internal combustion engine are formed in an end face (e.g., later-mentioned 21a) of the flange of the cylinder head; multiple openings (e.g., later-mentioned downstream openings 13a, 14a) corresponding to the multiple openings formed in the end face of the flange of the cylinder head are formed in an end face (e.g., later-mentioned end face 22a) of the flange of the exhaust member; and the gasket has a bead (e.g., later-mentioned bead 39) that protrudes toward any one of parts which are the cylinder head and the exhaust member, and, in plan view, is formed into a perfect circle or an edge-rounded rectangle having a straight part shorter than the radius of curvature thereof, that surrounds adjacent two or more openings from among multiple openings formed in the flange of the one part.

(2) In this case, it is preferable that a flange of any one of parts which are the cylinder head and the exhaust member include a partition wall part (e.g., later-mentioned partition wall portion 30) that separates the adjacent two openings as well as two passages connected to the two openings, and a weakened part (e.g., later-mentioned weakened portion 31) be provided in the thinnest part of the partition wall part.

(3) In this case, it is preferable that a cooling water passage (e.g., later-mentioned cooling water passages 27 to 29) through which cooling water flows be formed in the flange of the cylinder head, no passage through which cooling water passes be formed in the flange of the exhaust member, and the weakened part be formed in the partition wall part of the exhaust member.

(4) In this case, it is preferable that the partition wall part is a plate that extends in a flow direction of exhaust gas flowing through the two passages, and the weakened part is a groove that extends in the flow direction of the exhaust gas, and be formed on both sides of the partition wall part.

(5) In this case, it is preferable that the weakened part is a groove that is substantially V-shaped in cross-sectional view substantially perpendicular to the flow direction of the exhaust gas.

(6) In this case, it is preferable that the exhaust member is a turbine housing (e.g., later-mentioned turbine housing 4) of a turbocharger that compresses intake air by use of energy of exhaust gas of the internal combustion engine.

(7) In this case, it is preferable that the internal combustion engine includes multiple cylinders (e.g., later-mentioned cylinders CY1 to CY4), and the cylinder head has multiple bifurcated pipelines (e.g., later-mentioned bifurcated pipelines 7, 8, 9, 10) that extend from combustion chambers of the multiple cylinders, and multiple collecting pipelines (e.g., later-mentioned collecting exhaust pipelines 11, 12) that collect the exhaust gas flowing through the multiple bifurcated pipelines and guide the exhaust gas to the multiple openings. In the above explanation of the exemplary embodiment, specific elements with their reference numerals are indicated by using brackets. These specific elements are presented as mere examples in order to facilitate understanding, and thus, should not be interpreted as any limitation to the accompanying claims.

(1) In one embodiment, the gasket has a bead that protrudes toward any one of parts which are the cylinder head and the exhaust member, and, in plan view, is formed into a perfect circle or an edge-rounded rectangle having a straight part shorter than the radius of curvature thereof, that surrounds adjacent two or more openings from among multiple openings formed in the end face of the flange of the one part. Here, when high-temperature exhaust gas is continuously discharged through the multiple exhaust passages formed inside the flange of the cylinder head and the flange of the exhaust member, the end faces of the flanges deform such that an opening is formed (hereinafter, such deformation is referred to as “opening deformation”) due to heat of exhaust gas. The amounts of displacement due to such opening deformation is characterized by maximizing at the center, which is between the two adjacent openings, and decreasing concentrically from the center. According to this characteristic of the opening deformation of the end face of the flange, the flange joining structure has the circular or substantially circular (more specifically, an edge-rounded rectangle having a straight part shorter than the radius of curvature thereof) bead that surrounds the two or more adjacent openings, on a face of the plate-like gasket on the side of any of the parts which are the cylinder head and the exhaust member. When both of the flanges are joined through such a gasket, the bead formed in the gasket comes into contact with parts of both of the flanges where the amounts of displacement caused by the opening deformation are almost the same. Hence, even when opening deformation occurs due to the heat of exhaust gas, a substantially uniform contact pressure is applied on the gasket, so that the sealing property between both of the flanges can be maintained.

(2) In another embodiment, a flange of at least one of parts which are the cylinder head and the exhaust member includes a partition wall part that separates the adjacent two openings as well as two passages connected to the two openings. Such a partition wall part may crack due to thermal expansion, when high-temperature exhaust gas continuously flows through the two passages separated by the partition wall part. Moreover, the weakened part is provided in the thinnest part of the above partition wall part. Accordingly, upon occurrence of a thermal expansion large enough to cause a crack as mentioned earlier, the crack may be formed in the most easily breakable weakened part. In other words, since the flange joining structure can prevent occurrence of a crack in an unintended part other than the weakened part, behavior of the gasket can be stabilized, whereby the sealing property of the gasket can be maintained.

(3) In another embodiment, a cooling water passage through which cooling water flows is formed in the flange of the cylinder head, while no passage through which cooling water passes is formed in the flange of the exhaust member. For this reason, the temperature of the flange of the exhaust member tends to become higher than that of the flange of the cylinder head, and a crack is more likely to occur in its partition wall part due to thermal expansion. Moreover, the aforementioned weakened part is formed in the partition wall part of the flange of the exhaust member in which such a crack is more likely to occur. Hence, it is possible to prevent occurrence of a crack in an unintended part other than the weakened part of the partition wall part of the exhaust member, to stabilize behavior of the gasket, and maintain the sealing property of the gasket.

(4) In another embodiment, the partition wall part is a plate that extends in a flow direction of exhaust gas flowing through the two passages, and the weakened part is a groove that extends in the flow direction of the exhaust gas, and is formed on both sides (i.e., faces contacting the two passages) of the partition wall part. Hence, a crack can be formed in the partition wall part in the flow direction of the exhaust gas, behavior of the gasket can be stabilized even more, and therefore the sealing property of the gasket can be maintained more securely.

(5) In another embodiment, a groove substantially V-shaped in cross-sectional view substantially perpendicular to the flow direction of the exhaust gas is formed as the weakened part in the partition wall part. Hence, a crack can be caused more easily in the weakened part, behavior of the gasket can be stabilized even more, and therefore the sealing property of the gasket can be maintained more securely.

(6) In another embodiment, the exhaust member is a turbine housing of a turbocharger, and a flange formed in the turbine housing and the flange formed in the cylinder head are joined through the gasket. Since a turbocharger compresses intake air by use of energy of exhaust gas, it is preferable that the heat of exhaust gas be higher to improve turbine efficiency. The flange joining structure is applied to joining of the flange of the turbine housing through which such high-temperature exhaust gas flows and the flange of the cylinder head, whereby the aforementioned effect of maintaining the sealing property can be enhanced further.

(7) In another embodiment, the cylinder head has multiple bifurcated pipelines that extend from combustion chambers of the multiple cylinders, and multiple collecting pipelines that collect the exhaust gas flowing through the multiple bifurcated pipelines and guide the exhaust gas to the multiple openings of the flange. In other words, since the exhaust manifold is formed in the cylinder head of the flange joining structure, the number of parts can be reduced, and the device as a whole can be downsized. In addition, when the whole device is thus downsized, the temperature of exhaust gas flowing through the flange of the cylinder head tends to become high. Since the flange joining structure is applied to joining of the flange of the cylinder head through which such high-temperature exhaust gas flows and the flange of the exhaust member, the aforementioned effect of maintaining the sealing property can be enhanced even further.

### BRIEF DESCRIPTION OF THE DRAWINGS

The advantages of the disclosure will become apparent in the following description taken in conjunction with the following drawings.

FIG. 1 is a cross-sectional view of an internal combustion engine and a turbine housing connected to the internal combustion engine of one embodiment.

FIG. 2 is a side view of an exhaust passage formed by a cylinder head and the turbine housing.

FIG. 3 is a front view of the exhaust passage formed by the cylinder head and the turbine housing.

FIG. 4 is a perspective view of a gasket.

FIG. 5 is a cross-sectional view taken along line A-A of FIG. 1.

FIG. 6 is a cross-sectional view of a partition wall part, taken along a plane substantially perpendicular to a flow direction of exhaust gas.

FIG. 7 is a cross-sectional view taken along line B-B of FIG. 4.

### DETAILED DESCRIPTION

Hereinafter, an embodiment of the present disclosure will be described with reference to the drawings.

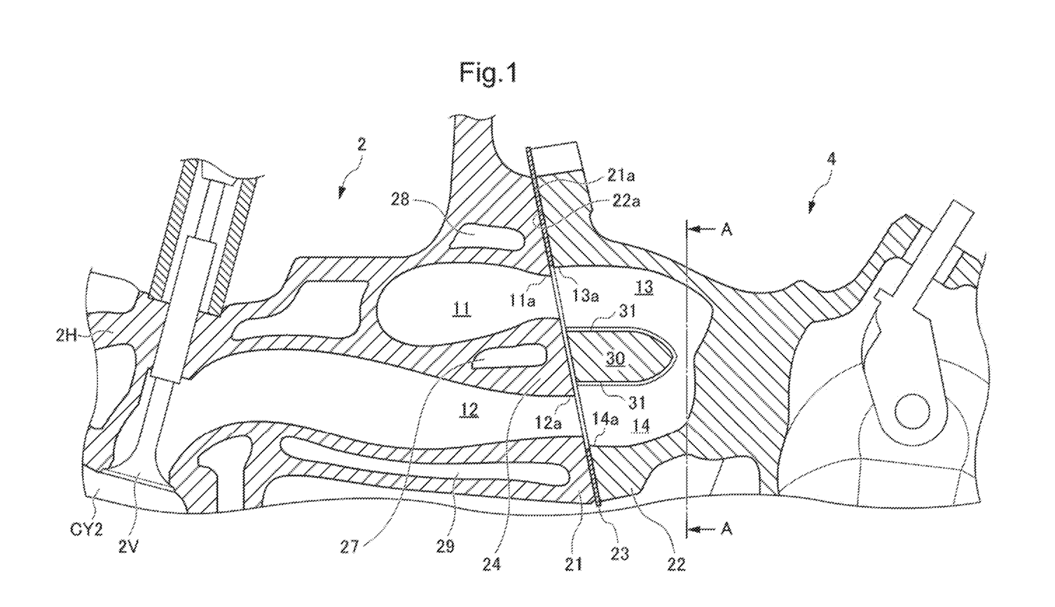

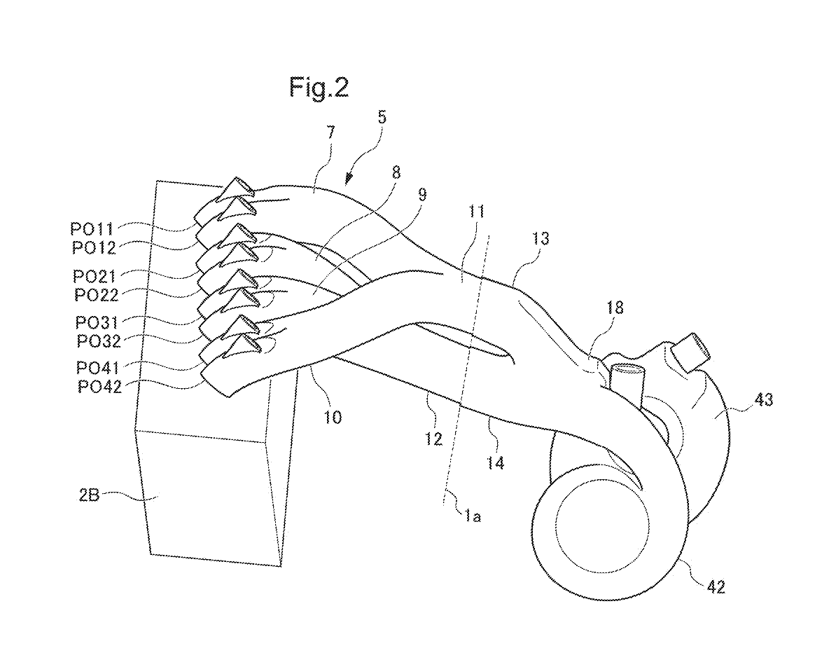

FIG. 1 is a cross-sectional view of an internal combustion engine 2 and a turbine housing 4 that are joined by applying a flange joining structure of the embodiment of the present disclosure. As will be described later with reference to FIG. 2 and other drawings, the internal combustion engine 2 is an inline-four engine configured by arranging multiple, or more specifically, four cylinders in series. FIG. 1 is a cross-sectional view including a second cylinder CY2 of the internal combustion engine 2 and the turbine housing 4.

The internal combustion engine 2 is configured by combining a cylinder block 2B in which multiple cylinders including the second cylinder CY2 are formed, and a cylinder head 2H provided with parts such as multiple exhaust passages that allow passage of exhaust gas discharged from combustion chambers in the cylinders, and exhaust valves 2V. The turbine housing 4 is a part of a turbocharger that compresses intake air of the internal combustion engine 2 by use of energy of exhaust gas of the internal combustion engine 2. The turbine housing 4 has an exhaust passage that introduces the exhaust gas discharged from the combustion chamber of the internal combustion engine 2 into an unillustrated turbine impeller room. Accordingly, when a flange 21 formed in the cylinder head 2H of the internal combustion engine 2 and a flange 22 formed in the turbine housing 4 are joined through a later-mentioned plate-like gasket 23, a single exhaust passage introducing the exhaust gas to the turbine impeller room from the combustion chamber in each cylinder of the internal combustion engine 2 is formed.

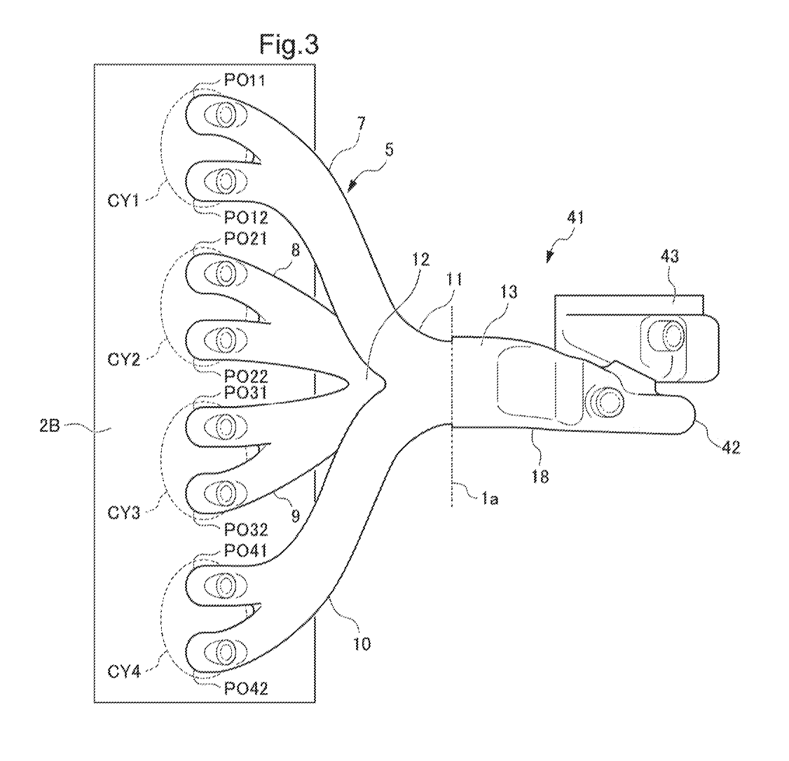

FIG. 2 is a side view of the pipe-like exhaust passage formed by the cylinder head 2H and the turbine housing 4. FIG. 3 is a plan view of the exhaust passage. Note that in FIGS. 2 and 3, the cylinder head 2H and the turbine housing 4 are omitted for simplicity of the description, while the exhaust passage and the cylinder block 2B formed by the cylinder head 2H and the turbine housing 4 are indicated by solid lines. In addition, of the exhaust passage illustrated in FIGS. 2 and 3, apart on the left side of a broken line la is a passage formed by the cylinder head 2H, and a part on the right side of the broken line 1a is passage formed by the turbine housing 4. Hereinafter, of the exhaust passage, the passage formed by the cylinder head 2H is also generically called an exhaust manifold 5. Meanwhile, of the exhaust passage, the passage formed by the turbine housing 4 is also generically called a housing passage 41.

As illustrated in FIG. 3, four cylinders CY1, CY2, CY3, CY4 arranged in series are formed in the cylinder block 2B. The exhaust manifold 5 has exhaust ports PO11, PO12 connected to the first cylinder CY1, exhaust ports PO21, PO22 connected to the second cylinder CY2, exhaust ports PO31, PO32 connected to the third cylinder CY3, and exhaust ports PO41, PO42 connected to the fourth cylinder CY4.

The exhaust manifold 5 includes a first bifurcated pipeline 7 connected to the exhaust ports PO11, PO12 on the upstream side, a second bifurcated pipeline 8 connected to the exhaust ports PO21, PO22 on the upstream side, a third bifurcated pipeline 9 connected to the exhaust ports PO31, PO32 on the upstream side, a fourth bifurcated pipeline 10 connected to the exhaust ports PO41, PO42 on the upstream side, a first upstream collecting exhaust pipeline 11 connected to the first bifurcated pipeline 7 and the fourth bifurcated pipeline 10 on the upstream side and collecting the exhaust gas flowing through the bifurcated pipelines 7, 10, and a second upstream collecting exhaust pipeline 12 connected to the second bifurcated pipeline 8 and the third bifurcated pipeline 9 on the upstream side and collecting the exhaust gas flowing through the bifurcated pipelines 8, 9.

The first bifurcated pipeline 7 is connected to the first cylinder CY1 through the two exhaust ports PO11, PO12 on the upstream side, and includes a Y-shaped junction passage that merges the exhaust gas from the exhaust ports PO11, PO12. The first bifurcated pipeline 7 is connected to the first upstream collecting exhaust pipeline 11 together with the fourth bifurcated pipeline 10 on the downstream side, and guides the exhaust gas from the exhaust ports PO11, PO12 to the first upstream collecting exhaust pipeline 11.

The second bifurcated pipeline 8 is connected to the second cylinder CY2 through the two exhaust ports PO21, PO22 on the upstream side, and includes a Y-shaped junction passage that merges the exhaust gas from the exhaust ports PO21, PO22. The second bifurcated pipeline 8 is connected to the second upstream collecting exhaust pipeline 12 together with the third bifurcated pipeline 9 on the downstream side, and guides the exhaust gas from the exhaust ports PO21, PO22 to the second upstream collecting exhaust pipeline 12.

The third bifurcated pipeline 9 is connected to the third cylinder CY3 through the two exhaust ports PO31, PO32 on the upstream side, and includes a Y-shaped junction passage that merges the exhaust gas from the exhaust ports PO31, PO32. The third bifurcated pipeline 9 is connected to the second upstream collecting exhaust pipeline 12 together with the second bifurcated pipeline 8 on the downstream side, and guides the exhaust gas from the exhaust ports PO31, PO32 to the second upstream collecting exhaust pipeline 12.

The fourth bifurcated pipeline 10 is connected to the fourth cylinder CY4 through the two exhaust ports PO41, PO42 on the upstream side, and includes a Y-shaped junction passage that merges the exhaust gas from the exhaust ports PO41, PO42. The fourth bifurcated pipeline 10 is connected to the first upstream collecting exhaust pipeline 11 together with the first bifurcated pipeline 7 on the downstream side, and guides the exhaust gas from the exhaust ports PO41, PO42 to the first upstream collecting exhaust pipeline 11.

The first upstream collecting exhaust pipeline 11 is connected to the bifurcated pipelines 7, 10 on the upstream side, merges the exhaust gas flowing through the first bifurcated pipeline 7 and the exhaust gas flowing through the fourth bifurcated pipeline 10, and guides the exhaust gas to the downstream turbine housing 4. The first upstream collecting exhaust pipeline 11 is connected to a later-mentioned first passage 13 of the turbine housing 4 on the downstream side. The first upstream collecting exhaust pipeline 11 guides the exhaust gas from the combustion chambers of a first cylinder group configured of the first cylinder CY1 and the fourth cylinder CY4, to the first passage 13 of the turbine housing 4.

The second upstream collecting exhaust pipeline 12 is connected to the bifurcated pipelines 8, 9 on the upstream side, merges the exhaust gas flowing through the second bifurcated pipeline 8 and the exhaust gas flowing through the third bifurcated pipeline 9, and guides the exhaust gas to the downstream turbine housing 4. The second upstream collecting exhaust pipeline 12 is connected to a later-mentioned second passage 14 of the turbine housing 4 on the downstream side. The second upstream collecting exhaust pipeline 12 guides the exhaust gas from the combustion chambers of a second cylinder group configured of the second cylinder CY2 and the third cylinder CY3, to the second passage 14 of the turbine housing 4

As illustrated in FIGS. 2 and 3, the housing passage 41 includes, from this order from the upstream side toward the downstream side, the first passage 13 connected to the first upstream collecting exhaust pipeline 11 of the exhaust manifold 5, the second passage 14 connected to the second upstream collecting exhaust pipeline 12 of the exhaust manifold 5, a Y-shaped junction passage 18 connected to the first passage 13 and the second passage 14, an annular scroll passage 42 for accelerating the exhaust gas flowing from the junction passage 18, and an impeller room 43 into which the exhaust gas accelerated by the scroll passage 42 flows and in which an unillustrated turbine impeller is stored.

The first passage 13 is connected to the first upstream collecting exhaust pipeline 11 of the exhaust manifold 5. The exhaust gas from the combustion chambers of the first cylinder group flows through the first passage 13. The second passage 14 is connected to the second upstream collecting exhaust pipeline 12 of the exhaust manifold 5. The exhaust gas from the combustion chambers of the second cylinder group flows through the second passage 14. The junction passage 18 is connected to the first passage 13 and the second passage 14, and merges the exhaust gas flowing through the first passage 13 and the exhaust gas flowing through the second passage 14.

Next, a joining structure of the cylinder head 2H and the turbine housing 4 will be described.

As illustrated in FIG. 1, the aforementioned first upstream collecting exhaust pipeline 11 and second upstream collecting exhaust pipeline 12 extending substantially parallel to each other are formed as through holes, in the flange 21 formed in the cylinder head 2H. In addition, a first upstream opening 11a communicating into the first upstream collecting exhaust pipeline 11, and a second upstream opening 12a communicating into the second upstream collecting exhaust pipeline 12 are formed in an end face 21a of the flange 21.

Additionally, the flange 21 of the cylinder head 2H includes a plate-like partition wall portion 24 that separates the first upstream collecting exhaust pipeline 11 and the first upstream opening 11a from the second upstream collecting exhaust pipeline 12 and the second upstream opening 12a, and extends in the flow direction of the exhaust gas. Moreover, in the flange 21, cooling water passages 27, 28, 29 throughwhich cooling water flows are formed around the pipelines 11, 12 through which the high-temperature exhaust gas flows.

The aforementioned first passage 13 and second passage 14 extending substantially parallel to each other are formed as through holes, in the flange 22 formed in the turbine housing 4. In addition, a first downstream opening 13a communicating into the first passage 13 and slightly larger than the aforementioned first upstream opening 11a, and a second downstream opening 14a communicating into the second passage 14 and slightly larger than the aforementioned second upstream opening 12a are formed in an end face 22a of the flange 22. As illustrated in FIG. 1, when the flange 21 of the cylinder head 2H and the flange 22 of the turbine housing 4 are joined to each other, the first upstream opening 11a faces the first downstream opening 13a, and the second upstream opening 12a faces the second downstream opening 14a. Thus, the first upstream collecting exhaust pipeline 11 is connected with the first passage 13, and the second upstream collecting exhaust pipeline 12 is connected with the second passage 14.

Additionally, the flange 22 of the turbine housing 4 includes a plate-like partition wall portion 30 that separates the first passage 13 and the first downstream opening 13a from the second passage 14 and the second downstream opening 14a, and extends in the flow direction of the exhaust gas. Note that unlike the flange 21 of the cylinder head 2H, the flange 22 does not have any passages through which cooling water flows.

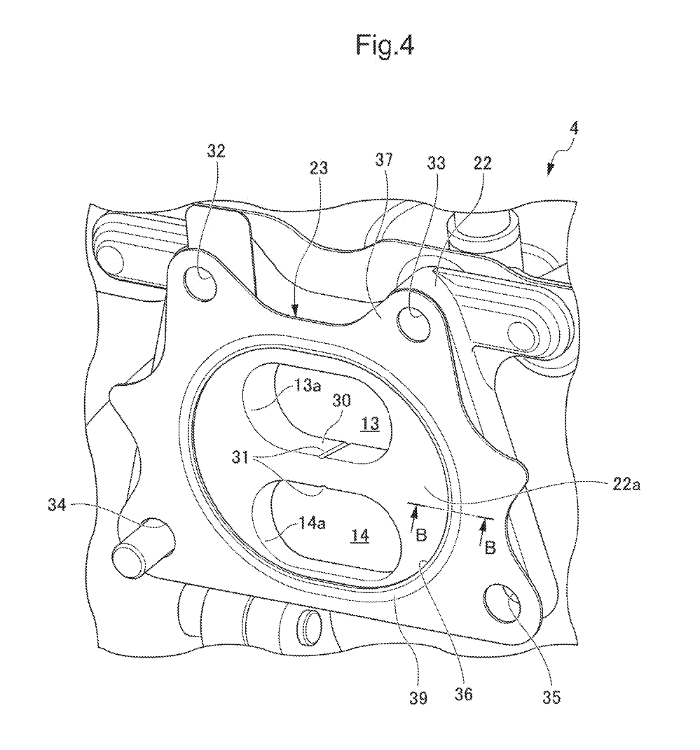

FIG. 4 is a perspective view of the gasket 23. More specifically, FIG. 4 is a perspective view of the gasket 23 assembled onto the flange 22 of the turbine housing 4.

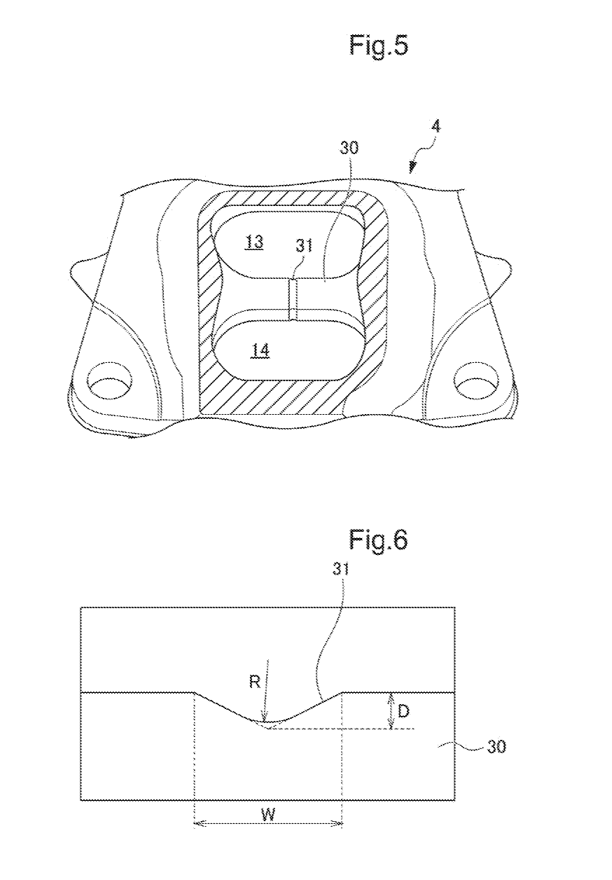

FIG. 5 is a cross-sectional view taken along line A-A of FIG. 1. More specifically, FIG. 5 is a view of the partition wall portion 30 as seen from the junction passage 18 side.

As illustrated in FIGS. 4 and 5, in the turbine housing 4, the partition wall portion 30 separating the first passage 13 from the second passage 14 has, in its center part having the smallest thickness, a weakened portion 31 which is a groove extending in the flow direction of the exhaust gas flowing through the passages 13, 14. The weakened portion 31 is formed in parts of the partition wall portion 30 except for an end part on the gasket 23 side, and extends over a face on the first passage 13 side, a face on the junction passage 18 side, and a face on the second passage 14 side.

FIG. 6 is a cross-sectional view of the partition wall portion 30, taken along a plane substantially perpendicular to the flow direction of the exhaust gas. The weakened portion 31 formed in the partition wall portion 30 is a substantially V-shaped groove in cross-sectional view. The weakened portion 31 has a width W of about 2 mm, and a depth D of about 0.5 mm, for example. Additionally, a bottom part of the weakened portion 31 is chamfered by an arc having a radius of curvature R of about 1 mm.

As illustrated in FIG. 4, the gasket 23 is formed into a plate shape, and has a total of four fastening holes 32, 33, 34, 35 respectively formed in four corners thereof. The cylinder head 2H and the turbine housing 4 are joined by providing the gasket 23 between the flanges 21, 22, inserting unillustrated bolts into the fastening holes 32 to 35 formed in the gasket 23, and fastening the bolts.

Additionally, the gasket 23 has, in its center, an opening 36 as a substantially circular through hole that surrounds the first downstream opening 13a and the second downstream opening 14a when the gasket 23 is placed on the end face 22a of the flange 22 of the turbine housing 4. Here, “substantially circular” is, more specifically, an edge-rounded rectangle having a straight part shorter than the radius of curvature thereof. Note that an “edge-rounded rectangle” is, more specifically, an oblong shape whose arcs are connected by parallel straight lines. Note that although the embodiment describes a case in which the shape of the opening 36 is substantially circular in plan view, the present invention is not limited to this, and the opening may be formed into a perfect circle.

Additionally, the gasket 23 has, on the outer side of the aforementioned opening 36, a substantially circular bead 39 that surrounds the first downstream opening 13a and the second downstream opening 14a in plan view. Note that although the embodiment describes a case in which the shape of the bead 39 is substantially circular in plan view, the present invention is not limited to this, and the bead may be formed into a perfect circle. In addition, as illustrated in FIG. 4, the bead 39 protrudes to the cylinder head 2H side. Note that although the embodiment describes a case in which the bead 39 protrudes to the cylinder head 2H side, the present invention is not limited to this, and the bead may protrude to the turbine housing 4 side.

As illustrated in FIG. 1, the first upstream opening 11a and second upstream opening 12a formed in the end face 21a of the flange 21 of the cylinder head 2H respectively face the first downstream opening 13a and second downstream opening 14a formed in the end face 22a of the flange 22 of the turbine housing 4. Hence, when the end face 21a of the flange 21 of the cylinder head 2H and the end face 22a of the flange 22 of the turbine housing 4 are joined through the gasket 23, the bead 39 formed in the gasket 23 surrounds the first upstream opening 11a and the second upstream opening 12a in plan view.

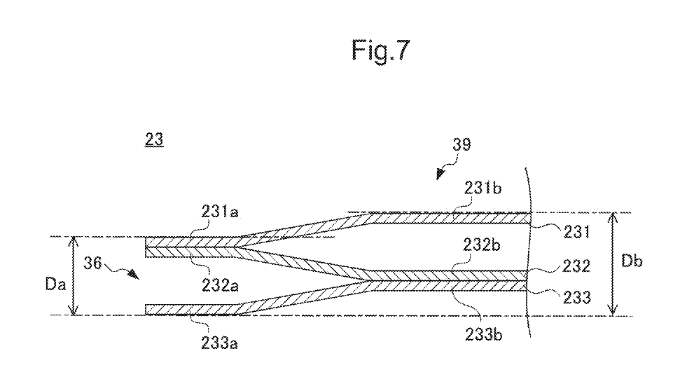

FIG. 7 is a cross-sectional view taken along line B-B of FIG. 4. To be more precise, FIG. 7 is a cross-sectional view taken along the thickness direction specifically of the opening 36 and the bead 39 of the gasket 23. Note that in FIG. 7, the upper part is the cylinder head 2H side and the lower part is the turbine housing 4 side.

As illustrated in FIG. 7, the gasket 23 is formed by layering multiple plates, more specifically, a first plate 231, a second plate 232, and a third plate 233. Of the three plates 231 to 233, the first plate 231 is in contact with the cylinder head 2H, and the third plate 233 is in contact with the turbine housing 4.

Three plates 231 to 233 have substantially the same shape in plan view, but have different sectional shapes. The first plate 231 has a first plane portion 231a in a part corresponding to the opening 36 in plan view, and a first protruding portion 231b protruding further to the cylinder head 2H side than the first plane portion 231a in a part corresponding to the bead 39 in plan view. The third plate 233 has a third plane portion 233a in a part corresponding to the opening 36 in plan view, and a third protruding portion 233b protruding further to the cylinder head 2H side than the third plane portion 233a in a part corresponding to the bead 39 in plan view. Additionally, the second plate 232 has a second plane portion 232a in a part corresponding to the opening 36 in plan view, and a second recessed portion 232b protruding further to the turbine housing 4 side than the second plane portion 232a in a part corresponding to the bead 39 in plan view.

The first plate 231 and the second plate 232 are at least joined at the first plane portion 231a and the second plane portion 232a, and spaced apart from each other in the thickness direction at the first protruding portion 231b and the second recessed portion 232b. The second plate 232 and the third plate 233 are joined at least in the second recessed portion 232b and the third protruding portion 233b, and spaced apart from each other in the thickness direction at the second plane portion 232a and the third plane portion 233a. By combining the three plates 231 to 233 described above in the gasket 23, a thickness Db of the bead 39 is made larger than a thickness Da of the opening 36

The flange joining structure of the embodiment has the following effects.

(1) In the flange joining structure of the embodiment, the plate-like gasket 23 has a substantially circular bead that protrudes to the cylinder head 2H side and surrounds the first upstream opening 11a and the second upstream opening 12a formed in the end face 21a of the flange 21 of the cylinder head 2H in plan view. Here, when high-temperature exhaust gas is continuously discharged through the upstream collecting exhaust pipelines 11, 12 formed inside the flange 21 of the cylinder head 2H, opening deformation occurs in the end face 21a of the flange 21. The amounts of displacement due to such opening deformation is characterized by maximizing at the center, which is between the two adjacent openings 11a, 12a, and decreasing concentrically from the center. According to this characteristic of the opening deformation of the end face 21a of the flange 21, the flange joining structure of the embodiment has the substantially circular bead 39 of the plate-like gasket 23 that protrudes to the cylinder head 2H side and surrounds the two adjacent openings 11a, 12a. When both of the flanges 21, 22 are joined through such a gasket 23, the bead 39 formed in the gasket 23 comes into contact with parts of both of the flanges 21, 22 where the amounts of displacement caused by the opening deformation are almost the same. Hence, even when opening deformation occurs due to the heat of exhaust gas, a substantially uniform contact pressure is applied on the gasket 23, so that the sealing property between both of the flanges 21, 22 can be maintained.

(2) In the flange joining structure of the embodiment, the flange 22 of the turbine housing 4 has the partition wall portion 30 that separates the two adjacent openings 13a, 14a, as well as the two passages 13, 14 respectively connected to the two openings 13a, 14a. Such a partition wall portion 30 may crack due to thermal expansion, when high-temperature exhaust gas continuously flows through the two passages 13, 14 separated by the partition wall portion 30. In the flange joining structure of the embodiment, the weakened portion 31 is provided in the thinnest part of the above partition wall portion 30. Accordingly, upon occurrence of a thermal expansion large enough to cause a crack as mentioned earlier, the crack may be formed in the most easily breakable weakened portion 31. In other words, since the flange joining structure of the embodiment can prevent occurrence of a crack in an unintended part other than the weakened portion 31, behavior of the gasket 23 can be stabilized, whereby the sealing property of the gasket 23 can be maintained.

(3) In the flange joining structure of the embodiment, the cooling water passages 27 to 29 through which cooling water flows are formed in the flange 21 of the cylinder head 2H, and such cooling water passages are not formed in the flange 22 of the turbine housing 4. For this reason, the temperature of the flange 22 of the turbine housing 4 tends to become higher than that of the flange 21 of the cylinder head 2H, and a crack is more likely to occur in its partition wall portion due to thermal expansion. Moreover, in the flange joining structure of the embodiment, the aforementioned weakened part is formed in the partition wall part of the flange of the exhaust member in which such a crack is more likely to occur. Hence, it is possible to prevent occurrence of a crack in an unintended part other than the weakened part of the partition wall part of the exhaust member, to stabilize behavior of the gasket 23, and maintain the sealing property of the gasket 23.

(4) In the flange joining structure of the embodiment, the partition wall portion 30 is a plate that extends in the flow direction of the exhaust gas flowing through the two passages 13, 14, while the weakened portion 31 is a groove that extends in the flow direction of the exhaust gas and formed on both sides of the partition wall portion 30. Hence, a crack can be formed in the partition wall portion 30 in the flow direction of the exhaust gas, behavior of the gasket 23 can be stabilized even more, and therefore the sealing property of the gasket 23 can be maintained more securely.

(5) In the flange joining structure of the embodiment, a groove that is substantially V-shaped in cross-sectional view substantially perpendicular to the flow direction of the exhaust gas, is formed as the weakened portion 31 in the partition wall portion 30. Hence, a crack can be caused more easily in the weakened portion 31, behavior of the gasket 23 can be stabilized even more, and therefore the sealing property of the gasket 23 can be maintained more securely.

(6) In the flange joining structure of the embodiment, the flange 22 formed in the turbine housing 4 of a turbocharger and the flange 21 formed in the cylinder head 2H are joined through the gasket 23. Since a turbocharger compresses intake air by use of energy of exhaust gas, it is preferable that the heat of exhaust gas be higher to improve turbine efficiency. The flange joining structure of the embodiment is applied to joining of the flange 22 of the turbine housing 4 through which such high-temperature exhaust gas flows and the flange 21 of the cylinder head 2H, whereby the aforementioned effect of maintaining the sealing property can be enhanced further.

(7) In the flange joining structure of the embodiment, the cylinder head 2H has the four bifurcated pipelines 7 to 10 extending from the combustion chambers of the four cylinders CY1 to CY4, and the two collecting exhaust pipelines 11, 12 that collect the exhaust gas flowing through the bifurcated pipelines 7 to 10 and guide the exhaust gas to the multiple openings 11a, 12a of the flange 21. In other words, since the exhaust manifold 5 is formed in the cylinder head 2H of the flange joining structure of the embodiment, the number of parts can be reduced, and the device as a whole can be downsized. In addition, when the whole device is thus downsized, the temperature of exhaust gas flowing through the flange 21 of the cylinder head 2H tends to become high. Since the flange joining structure of the embodiment is applied to joining of the flange 21 of the cylinder head 2H through which such high-temperature exhaust gas flows and the flange 22 of the turbine housing 4, the aforementioned effect of maintaining the sealing property can be enhanced even further.

Note that the present invention is not limited to the above embodiment, and modifications, improvements, and the like within the scope of achieving the objective of the disclosure are included in the invention.

Although the above embodiment describes a case of forming the weakened portion 31 in the partition wall portion 30 formed in the turbine housing 4, the present invention is not limited to this. A weakened part may also be formed in a part of the cylinder head 2H where high-temperature exhaust gas flows, that is, the partition wall portion 24 formed in the cylinder head 2H. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

1. A flange joining structure comprising:
a first flange provided to a cylinder head of an internal combustion engine;
a second flange provided to an exhaust member; and
a gasket, the first flange and the second flange being joined via the gasket therebetween,
wherein:
a plurality of openings of a plurality of exhaust passages connected to a combustion chamber of the internal combustion engine are provided in an end face of the first flange,
a plurality of openings corresponding to the plurality of openings provided in the end face of the first flange are provided in an end face of the second flange, and
the gasket includes a bead that protrudes toward one of the first flange and the second flange, and, in plan view, the bead is shaped into a circle, an oval or an edge-rounded rectangle having a straight part shorter than the radius of curvature thereof, and in the plan view, the bead surrounds adjacent two or more openings from among the plurality of openings provided in the one of the first flange and the second flange.

2. The flange joining structure according to claim 1, wherein:
one of the first flange and the second flange includes a partition wall part that separates the adjacent two openings as well as two passages connected to the two openings; and
a weakened part is provided in the thinnest part of the partition wall part.

3. The flange joining structure according to claim 2, wherein:
the second flange includes a partition wall part,
a cooling water passage through which cooling water flows is provided in the first flange;
no passage through which cooling water passes is provided in the second flange; and
the weakened part is provided in the partition wall part of the second flange.

4. The flange joining structure according to claim 2, wherein:
the partition wall part is a plate that extends in a flow direction of exhaust gas flowing through the two passages; and
the weakened part is a groove that extends in the flow direction of the exhaust gas, and is provided on two side surfaces of the partition wall part, the two side surfaces being opposite to each other.

5. The flange joining structure according to claim 4, wherein
the weakened part is a groove that is substantially V-shaped in cross-sectional view substantially perpendicular to the flow direction of the exhaust gas.

6. The flange joining structure according to claim 1, wherein
the exhaust member is a turbine housing of a turbocharger that compresses intake air by use of energy of the exhaust gas of the internal combustion engine.

7. The flange joining structure according to claim 6, wherein:
the internal combustion engine includes a plurality of cylinders; and
the cylinder head includes
a plurality of bifurcated pipelines that extend from combustion chambers of the plurality of cylinders, and
a plurality of collecting pipelines that collect the exhaust gas flowing through the plurality of bifurcated pipelines and guide the exhaust gas to the plurality of openings.

8. The flange joining structure according to claim 1, wherein the bead is shaped into a perfect circle.

9. The flange joining structure according to claim 1, wherein the gasket includes a surrounding opening surrounds the adjacent two or more openings, and the bead is provided along an edge of the surrounding opening.

10. The flange joining structure according to claim 1, wherein the gasket includes a plurality of plates stacked one another.

11. A vehicle comprising the flange joining structure according to claim 1.
